(19) United States
(12) Patent Application Publication
(10) Pub. No.: US 2008/0102184 A1
(43) Pub. Date: May 1, 2008

(54) CHUNKY SALAD DRESSING

(75) Inventors: Leonardo Jose Sanchez AQUINO, Jersey City, NJ (US); Ashley Kate SHERMAN, Oakland, NJ (US); Steven Martin RIKON, Ringwood, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: CONOPCO, INC., D/B/A UNILEVER, Englewood Cliffs, NJ (US)

(21) Appl. No.: 11/553,646

(22) Filed: Oct. 27, 2006

(51) Int. Cl. A23L 1/40

(52) U.S. Cl. 426/589

(57) ABSTRACT

A substantially fat free pourable salad dressing with food particulates is described, such that the salad dressing has a flavor, aroma, color and appearance that is “just right”. The food particulates are substantially cubical, having a side length of at least about 0.64 cm, and comprise about 15% to about 45% of the system. The chunky salad dressing system, in addition to the food particulates, includes an aqueous solution comprising a mixture of at least about 0.20% acetic acid and at least about 0.10% inorganic acid at a pH of less than about 4.5.

### FIELD OF THE INVENTION

The present invention is directed to a food system with food particulates. In particular, the present invention is directed to salad dressing with substantially cubical food particulates having a side length of at least about 0.64 cm.

### BACKGROUND OF THE INVENTION

Pourable salad dressings are commonly used to coat and flavor salads, and as an adjunct on vegetables, sandwiches and other foods. Many attempts have been made to formulate good quality low fat pourable salad dressings. Typically, relatively large quantities of acetic acid have been used to achieve microbial stability of the salad dressing. Large food particulates, however, are not a common inclusion in a salad dressing, particularly a low fat or non-fat pourable salad dressing.

Relatively large food particulates in an aqueous system are especially difficult to make microbiologically stable and safe while avoiding a flavor that is unacceptable to consumers from a taste standpoint in foods such as a salad dressing. For example, consumers may dislike the particulate flavor if the taste is that of “pickled” food. At the same time, it is of increasing interest to develop substantially fat free salad dressings having relatively large food particulates.

This invention, therefore, is directed to a substantially fat free salad dressing system with relatively large particulates, comprising:
(a) food particulates having a substantially cubical shape and having a side length of at least about 0.64 cm;
(b) an aqueous solution comprising a mixture of at least about 0.20% acetic acid and at least about 0.10% inorganic acid.

The food composition is unexpectedly microbiologically stable and safe, in the absence of heat treatment, while at the same time possessing excellent taste, olfactory, texture and visual characteristics.

### ADDITIONAL INFORMATION

Dressing products where use of buffering salts is described are disclosed in U.S. Pat. Nos. 4,927,657 and 4,352,832.

U.S. Pat. No. 5,508,055 discloses a salad dressing containing food pieces that are smaller than ¼ inch.

None of the additional information above describes a unique substantially fat free salad dressing that is shelf-stable without heat treatment, that employs relatively large food particulates in an aqueous medium and provides “just right” flavor and texture of the particulates in the salad dressing.

### SUMMARY OF THE INVENTION

To overcome one or more of the disadvantages of the prior art, the present invention is directed to a pourable, substantially fat free, salad dressing with food particulates in an aqueous medium comprising:
(a) food particulates having a substantially cubical shape and having a side length of at least about 0.64 cm;
(b) an aqueous solution comprising a mixture of at least about 0.20% acid and at least about 0.10% inorganic acid;
   where the pourable salad dressing with food particulates has a “just right” flavor, aroma and texture, and is microbiologically safe and stable while free of thermal processing.

Preferably, the composition is translucent, provides a tactile experience of chunks in the mouth, and is completely edible, providing a consumer with an excellent organoleptic experience.

Food composition, as used herein, means a composition suitable for consumption in its entirety by humans, including a filling, dip, sauce, spread, topping, dressing, marinade, beverage or the like, preferably salad dressings, and more preferably a substantially fat free salad dressing.

“Just right” as used herein relates to consumer rating scale as determined by the Synovate norm used by CMI company, whereby at least about 75% of consumers, and preferably at least about 80% of consumers, surveyed found the product in the bottle just right in terms of overall color (not too dark nor too light) of salad dressing, number of vegetables pieces and visible herbs (neither too few nor too many), the size of the vegetable pieces in the product (neither too large nor too small), as well as the overall flavor and aroma.

Microbiologicaily stable (i.e., spoilage free) means no outgrowth of spoilage bacteria, yeast and/or mold and no flavor loss attributable to microorganism activity for at least about one (1) month, and preferably, for at least about one (1) year before opening and when kept at room temperature of about 20 to about 25° C. and at a pH of less than about 5.0. Microbiologically safe (for products kept at about 20 to about 25° C.) means preventing the outgrowth of pathogens (like Listeria monocytogenes) for at least about one (1) month, and preferably, for at least about one (1) year before opening and when kept at room temperature.

Free of thermal processing means in the absence of hot filling, retorting and pasteurization steps and package filling under conventional cold fill conditions.

Substantially fat free as used herein means less than about 15% oil, preferably less than about 5% oil, and more preferably about 0% to about 3% oil.

Relatively large food particulates according to the present invention means substantially cubically shaped particulates, or chunks, having a side length of at least about 0.64 cm.

The food particulate (or substantially cubical chunk) size may range from about 0.64 cm to about 1.27 cm in side length, with preferably at least 10% of the food particles by weight of the total amount of solid particulates having a side length of at least about 1.1 cm. Illustrative examples of the types of food particulates for use in this invention include fruit, vegetables, cheese, nuts, seeds, meat, fish (e.g., tuna), crustaceans, poultry products, bacon, bread, or a mixture thereof, preferably fruit, vegetables, or a mixture thereof. Preferred vegetables include peppers, carrots, mushrooms, and tomatoes. Most preferably, the fruit and/or vegetable particulates are sourced as individually quick frozen (IQF) particles, which may be quickly blanched or surface treated prior to the quick freezing. The food particulates comprise about 15% to about 45% by weight of the dressing, preferably about 20% to about 40% of fruit and/or vegetable particulates. Preferably but optionally, smaller food, herb or spice particles are not excluded from the preservative system according to the present invention, as long as the food particulates as described above are necessarily present.

The aqueous solution contains at least about 0.20% acetic acid and at least about 0.10% inorganic acid. Preferably, the acetic acid makes about 0.20% to about 1.0% by weight of the system, more preferably about 0.60% to about 0.80%. The inorganic acid may be phosphoric acid, hydrochloric acid, or mixtures thereof. Preferably, the inorganic acid makes about 0.10% to about 1.0% by weight of the system, more preferably about 0.25% to about 0.50%, and most preferably, about 0.30%. The ratio of acetic acid to inorganic acid is adjusted so as to achieve a pH of less than about 5.0, while avoiding pickled flavor of food particulates. Water makes up the balance of the system, at about 55% to about 95% by weight of the system.

The food compositions of this invention preferably have a pH of about 3.0 to 5.0, and most preferably, about 3.5 to about 4.5. However, the food particulates preserved the system of this invention, unexpectedly, are not vinegary tasting even when the same are formulated to have a pH at about 3.0.

The salad dressing system is entirely edible. Preferably, the system is substantially translucent, substantially fat free, and has a Brookfield viscosity of about 100-4,500 cps at a temperature of about 5 deg. C. to about 35 deg. C.

The salad dressing system including relatively large particles in an aqueous medium according to the present invention may further contain optional ingredients.

The salad dressing system may include a thickening system. The thickening system may comprise carageenan, xanthan gum, or a mixture thereof Preferably, enough thickener is used in combination with the other ingredients to achieve a Brookfield viscosity of 200-4,000 centipoise at ambient temperature of about 25 deg. C.

Chelating agents, or compounds that bind and/or isolate another compound or element, suitable for use in this invention include EDTA; phosphates, like sodium acid pyrophosphate, trisodium pyrophosphate, tetrasodium pyrophosphate, sodium hexametaphosphate, trisodium phosphate; lactoferrin; lactoferricin B; ovotransferrin; phytic acid; sumarin; and curcumin.

Aromatic preservatives suitable for use in this invention include benzoic acid, coumaric acid, salicylic acid, vanillic acid, caffeic acid, cinnamic acid, ferulic acid, and mixtures thereof. Esters suitable for use in this invention include a C₁-C₈ parabens, C₁-C₄ phytates, as well as preservatives derived from acids and arginine, like the ethyl ester of the lauramide of arginine monohydrochloride (LAE). Further acids may optionally be included, such as sorbic, formic, propanoic, 2-hydroxypropanoic (i.e., lactic), butyric, valeric, adipic, gluconic, malic, fumaric, citric, tartaric, ascorbic, salicyclic and carnosic acid, including mixtures thereof.

When preparing the salad dressing system of this invention, a premix of the aqueous solution may be prepared prior to adding in the food particulates, or, the aqueous components may be added to the food particulates without regard to order of addition.

Also, the salad dressings of this invention can optionally comprise soluble fibers, insoluble fibers, gums (like xanthan), starches, cellulose, vitamins, buffers, antioxidants, preservatives (like sorbates and benzoates), colorants, emulsifiers, alcohol, spices (including salt), syrups, milk, food grade dispersants or stabilizers (like propylene glycol alginate), solubilizing agents (like propylene glycol), milk powder or mixtures thereof.

The packaging suitable for use with the food compositions made according to this invention is often a glass or plastic jar, food grade sachet, a plastic tub or squeezable plastic bottle. Sachets are preferred for food service applications.

The following examples are provided to illustrate an understanding of the present invention. The examples are not intended to limit the scope of the claims.

### EXAMPLE 1

A pourable dressing of this invention was made as a by adding the following ingredients:

TABLE 1

| Ingredient | Percent |
|---|---|
| Water | Balance |
| Vegetables* | 20.500 |
| Spices | 2.42 |
| Potassium sorbate | 0.100 |
| Sodium benzoate | 0.100 |
| Gums | 0.200 |
| Acetic Acid** | 0.600 |
| Phosphoric Acid (85%)*** | 0.500 |

*sweet red pepper; mild green IQF jalapeno pepper; carrot chunks - all about 0.65 cm in length
**0.85% solution in water, obtained from Mizkan Americas Inc., Mt. Prospect, Illinois
***H₃PO₄, obtained from Astaris, St. Louis, Missouri

### EXAMPLE 2

Chunky salad dressing of this invention was made by adding the following ingredients.

TABLE 2

| Ingredient | Percent by weight |
|---|---|
| Water | balance |
| Vegetables* | 22.00 |
| Spices | 2.24 |
| Gums | 0.100 |
| Acetic Acid** | 0.800 |
| Sodium Benzoate | 0.100 |
| Potassium sorbate | 0.100 |
| Phosphoric Acid 85%*** | 0.380 |
| Soybean Oil | 0.500 |

*sweet green bell pepper, carrot chunks about 1.27 cm in length
**0.85% solution in water, obtained from Mizkan Americas Inc., Mt. Prospect, Illinois
***H₃PO₄, obtained from Astaris, St. Louis, Missouri

The resulting chunky salad dressing had a pH of about 3.6.

### EXAMPLE 3

A unique salad dressing according to this invention was made by adding the following ingredients.

TABLE 3

| Ingredient | Percent by weight |
|---|---|
| Water | balance |
| Vegetables* | 22.00 |
| Spices | 2.24 |
| Gums | 0.100 |
| Distilled White Vinegar | 6.00 |
| Sodium Benzoate | 0.100 |
| Potassium sorbate | 0.100 |
| Phosphoric Acid 75%*** | 0.44 |
| Soybean Oil | 1.00 |

*sweet green bell pepper, carrot chunks about 1.27 cm in length
**0.85% solution in water, obtained from Mizkan Americas Inc., Mt. Prospect, Illinois

The resulting chunky salad dressing had a pH of about 3.0.

The salad dressings of Examples 1, 2 and 3 were each placed in about ten (10) sealed twelve (12) weight ounce (340 g) polypropylene bottles and stored at ambient temperature of about 20-25 deg. C. Surprisingly, the salad dressings made according to this invention were shelf stable for period of a year. No outgrowth of bacteria, yeast and/or mold was observed.

Most surprisingly, the vegetable chunks of Examples 1-3, after confirmation by ten (10) panelists who sampled the products, had a lack of the undesirable vinegary taste. The salad dressing, after confirmation was fresh tasting, and had excellent overall taste of the vegetables, excellent olfactory, excellent texture of the vegetables in particular and good visual characteristics on salad and of the vegetable particulates specifically, even after a year.

Uniqueness ratings for both products were very high. Eighty to ninety percent of one hundred random consumer respondents rated the products “extremely or very new and different,” with half rating them as being “extremely different.” Greater than 75% of respondents also rated the aroma, the consistency of feeling in the mouth, texture of the carrot, tomato, green and red pepper particulates as “just right” (e.g. not too creamy, not too grainy, etc.)

A one week home use test was conducted with the Hearty Italian variety of the formulation of Example 3 among people aged 18-64 who purchased salad dressing in the past 3 months and eat salad 3 or more times per week. The overall acceptability of the product was very good, exceeding Synovate's food norm of 39%.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A chunky pourable salad dressing comprising:
(a) food particulates having a substantially cubical shape and having a side length of at least about 0.64 cm;
(b) an aqueous solution comprising a mixture of at least about 0.20% acetic acid and at least about 0.10% inorganic acid;
wherein said salad dressing is substantially fat free; and
wherein the salad dressing has a flavor, aroma and texture that is “just right” and is microbiologically stable and safe while free of thermal processing.

2. The chunky salad dressing according to claim 1 wherein said particulates comprise fruit, vegetables, cheese, nuts, seeds, meat, or a mixture thereof.

3. The chunky salad dressing according to claim 1 wherein said particulates comprise fruit, vegetables, or a mixture thereof.

4. The chunky salad dressing according to claim 1 wherein said substantially cubical particulates have a side length of about 0.64 cm to about 1.27 cm.

5. The chunky salad dressing according to claim 1 wherein said inorganic acid is phosphoric acid, hydrochloric acid, or a mixture thereof.

6. The chunky salad dressing according to claim 1 wherein said inorganic acid makes about 0.20% to about 1.0% by weight of the food composition.

7. The chunky salad dressing according to claim 1 wherein said inorganic acid makes about 0.30% by weight of the food composition.

8. The chunky salad dressing according to claim 1 wherein said system is entirely edible further comprising antimicrobials, an antibiotic, chelating agent, aromatic preservative, ester, enzyme, or a mixture thereof.

9. The chunky salad dressing according to claim 1 wherein said system is microbiologically safe and stable for a period of at least about one (1) year.

10. The chunky salad dressing according to claim 1 wherein said system is substantially translucent.

11. The chunky salad dressing according to claim 1 having a viscosity of about 100 to about 4,500 cps at a temperature of about 5 deg. C. to about 35 deg. C.

12. The chunky salad dressing according to claim 1 wherein said particulates comprise about 15% to about 45% by weight of said dressing system.

13. The chunky salad dressing according to claim 13 wherein the composition is a dip, filling, sauce, spread, topping, dressing, marinade or beverage.

14. The chunky salad dressing according to claim 13 further comprising a thickening system comprising carageenan, xanthan gum, or a mixture thereof.

15. The chunky salad dressing according to claim 1 having a pH of less than about 4.5.
